(19) United States
(12) Patent Application Publication
(10) Pub. No.: US 2025/0275102 A1
(43) Pub. Date: Aug. 28, 2025

(54) A SYSTEM FOR INTEGRATION OF DATA CENTERS AND HIGH DENSITY FARMING

(71) Applicant: Matthew MORRIS, Lutherville, MD (US)

(72) Inventor: Matthew MORRIS, Lutherville, MD (US)

(21) Appl. No.: 18/857,312

(22) PCT Filed: Apr. 26, 2023
(86) PCT No.: PCT/US2023/019895

§ 371 Date: Oct. 16, 2024

Related U.S. Application Data
(60) Provisional application No. 63/334,812, filed on Apr. 26, 2022.

(51) Int. Cl. H05K 7/20; A01G 9/24

(52) U.S. Cl. CPC H05K 7/20836; A01G 9/246

(57) ABSTRACT

A system for integration of data centers and high density fanning is disclosed. By integrating these two asset types, heat waste from a data center can be used to reduce heating ventilation air conditioning costs for a high density fanning facility thereby reducing electric costs and greenhouse gas emissions. The high density farming acts as a cost-effective heat sink and carbon capture for the data center.

### CROSS REFERENCE TO RELATED APPLICATIONS

This application claims priority to Application No. 63/334,812, filed Apr. 26, 2022, the entire contents of which is hereby incorporated in total by reference.

### FIELD OF THE INVENTION

The invention relates generally to improving data center operating efficiency. More specifically, it relates to the use of data center building climate control system exhaust. It is a method and system of utilizing data center waste exhaust to supply high density farming with consistently conditioned air while reducing greenhouse gas emissions through increased efficiency and plant photosynthesis.

### BACKGROUND

More sustainability is needed in the data center industry due to the industry's significant size and heavy resource use. High density farming has several large challenges that prevent it from reaching large scale. A solution to problems with both data centers (“DC” or “DCs”) and high density farming (“HDF”) is required.

DCs exhaust substantial wasted thermal energy that could be recycled. This is especially true for older legacy DCs with higher power usage effectiveness (“PUE”). Even a very efficient DC produces significant heat. Most of the power that is input into information technology (“IT”) equipment is transformed into heat output. Excess heat must be removed from IT equipment and surrounding area to prevent destruction of electronic components. One challenge of wasted DC thermal energy is that the waste heat is warm, but not hot enough to be efficiently converted to other forms of energy. Additional energy would need to be added for steam driven electrical generation, for example. A unique characteristic of DC waste heat is that it is consistent because DCs operate with almost no downtime.

DCs are responsible for significant greenhouse gas (“GHG”) emissions. Most DCs are on an electrical grid. GHG emissions are a byproduct of energy generation at large scale. GHG emission estimates per unit of energy by electrical grid is known. The amount of electricity required for DCs is significant and reduces sustainability. Reducing electric use reduces GHG emissions. Additionally, many DCs have mechanical operations that require GHG producing fossil fuels. Uninterrupted power supply systems supported by diesel generators are an example. Capturing actual carbon dioxide from mechanical systems would improve DC GHG emissions.

Many DC customers are demanding sustainability and lower carbon footprint throughout their value chain. DCs need to be more environmentally friendly to better serve customers that prioritize lower carbon footprint. Many companies have goals to reduce direct and indirect GHG emissions. There is mounting pressure from governments, communities, investors, employees, and customers to ensure sustainability credentials in company supply chains, including DCs.

National governments consider GHG emissions when regulating industries that use substantial energy resources. Local communities and municipalities consider GHG emissions and other factors when a DC is planned in their community. Reducing the production of GHG emissions increases sustainability and would improve government and community interactions. Reducing GHG emissions reduces regulatory risk.

Large scale HDF has specific real estate requirements. Certain HDF embodiments require ceiling height to be over 30 feet high. They also require trucking access and proximity to trucking routes. HDF is also typically closer to population centers to reduce transportation cost. HDF operates with almost no downtime which creates the need for power stability and redundancy. In most cases industrial space is most appropriate. HDF has had to compete for industrial space as market forces push up rents and lower the amount of available space. This is in part due to the expansion of large-scale ecommerce companies. Increasingly expensive industrial space creates a significant economic barrier for HDF to reach scale.

HDF requires significant HVAC capital investment. Most industrial space is not well insulated or heated. Additional capital investment in robust HVAC is additional cost over market industrial rents or typical industrial building development costs. HDF bears the cost of additional capital investment regardless of if the space is leased, bought, or built-to-suit. Significant HVAC capital investment creates an economic barrier for HDF to reach scale.

HDF electric operating expenses are significant. HVAC and lighting costs are the most significant uses of electricity in HDF. The amount of electricity required for HDF is an economic challenge and reduces sustainability. Reducing electric use improves the economics of HDF as well as reduces GHG emissions. Reducing electric costs will allow HDF to better compete against traditional outdoor farming.

Vegetation in HDF requires carbon dioxide for photosynthesis. To increase vegetation growth, carbon dioxide can be added at a level above ambient levels in the earth's atmosphere.

What is needed are methods and systems to address these and other problems related to DC and HDF.

### SUMMARY

One aspect of the invention provides a system including a data center (DC). The DC includes a plurality of information technology (IT) equipment. The DC also includes a heating-ventilation-and-air-conditioning (HVAC) system including conduit. The HVAC system is configured and adapted to remove thermal energy from the plurality of IT equipment. The system also includes a high density farming (HDF) system in proximity to the DC. The HDF system being configured and adapted to support vegetation. The HVAC system is configured and adapted to provide the removed thermal energy to the HDF system through a conditioned fluid.

Another aspect of the invention provides a method including: (a) providing a data center (DC) including: a plurality of information technology (IT) equipment; and a heating-ventilation-and-air-conditioning (HVAC) system configured and adapted to remove thermal energy from the plurality of IT equipment, the HVAC system including conduit; and (b) providing a high density farming (HDF) system in proximity to the DC; wherein the HVAC system is configured and adapted to provide the removed thermal energy to the HDF system via a conditioned fluid.

### BRIEF DESCRIPTION OF THE DRAWINGS

FIG. 1 schematically illustrates, in an out of scale manner, an exterior view of an embodiment of the invention retrofit to an existing DC with temporary HDF design.

FIG. 2 schematically illustrates, in an out of scale manner, a partially sectional side view of an embodiment of invention with a containerized HDF system.

FIG. 3 schematically illustrates, in an out of scale manner, a partially sectional side view of an embodiment of the invention with rooftop HDF and a radiant heating system.

### DEFINITION

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, the preferred materials and methods are described herein. In describing and claiming the present invention, the following terminology will be used.

It is also to be understood that the terminology used herein is for the purpose of describing particular embodiments only, and is not intended to be limiting.

The articles “a” and “an” are used herein to refer to one or more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% from the specified value, as such variations are appropriate to perform the disclosed methods.

The term ‘Data Center’ (“DC” or “DCs”) hereinafter refers to, but is not limited to, Enterprise, Co-location, and/or Hyperscale DCs. It applies to DC buildings, DC rooms, containerized DCs, DC modules and units. It applies to both single and multi-occupant DCs. The present invention is by no way limited by a DCs source of power, or the type of HVAC used.

The term ‘High Density Farming’ (“HDF”) hereinafter refers to, but is not limited to, vertical farming, containerized farming, modular farming, hydroponics, aeroponics, aquaponics, aquaculture, and similar farming techniques that increase density relative to traditional outdoor farming. It applies to HDF buildings, HDF rooms, containerized HDF, HDF modules and units.

The term ‘Heating Ventilation Air Conditioning’ (“HVAC”) hereinafter refers to, but is not limited to, air handling units, air-cooled chillers, water-cooled chillers, cooling towers, evaporators, evaporative cooling units, economization or free-cooling systems, rooftop units, heat pumps, variable refrigerant flow systems, computer room air conditioning units, variable air volume systems, humidifiers, dehumidifiers, integrated controls between such equipment, and similar equipment found in a DC or HDF. HVAC controls a space's temperature, humidity, circulation, cleanliness, and freshness.

### DETAILED DESCRIPTION

Disclosed herein is a system to use waste exhaust from DCs to reduce climate control costs for a rooftop, adjacent, or integrated HDF operations, and reduce greenhouse gas (GHG) emissions through increased efficiency and plant photosynthesis.

By integrating DC and HDF, heat waste from a DC can be used to reduce HVAC costs for a HDF facility thereby reducing electric costs and GHG emissions. The HDF acts as a cost-effective heat sink and carbon capture for the DC.

### Economic Aspects

In 2014, United States' DCs consumed an estimated 70 Billion kWh, or 1.8% of total US consumption, according to the United States Data Center Energy Usage report (Data Center Energy Efficiency). It is very likely that this figure has only increased due to the number of new DCs that have been constructed after 2014. Average IT equipment density has also only increased since. This density increase applies to number of servers per rack as well as power requirement per server. CBRE estimates total United States DC inventory of 3,358 MW with 728 MW under construction. 2021 absorption alone was 493.4 MW (North America Data center Trends H2 2021|CBRE). At this scale, DC efficiency and sustainability impacts many stakeholders and has caused higher scrutiny of resource use. Many companies have started to demand sustainability and lower carbon footprint throughout their value chain, both DC operators and their customers. DCs need to be more environmentally friendly to attract customers that prioritize lower carbon footprint. Many companies have goals to reduce direct and indirect GHG emissions. There is mounting pressure from investors, employees, and customers to ensure sustainability credentials in their supply chains. Sustainability is an environmental and political issue. Enhancing sustainability also reduces an organization's long-term regulatory risk. A recent survey of multi-tenant DC operators by S&P found 43% indicated they have sustainability initiatives in place.

DC operators care deeply about energy efficiency. For large DC, electricity is the costliest operating expense. Electricity that goes into a DC is distributed to 1) IT equipment (servers, networking equipment, ect . . . ) and 2) infrastructure that supports IT equipment (HVAC, lighting, power distribution units, uninterruptible power supplies). Some of the power that is input into servers is transformed into heat output. Excess heat must be removed from the server and surrounding area to prevent destruction of electronic components. This heat byproduct creates the need for robust HVAC in a DC.

One important efficiency metric used in the DC industry for efficiency benchmarking is Power Usage Effectiveness (“PUE”). PUE is a ratio between total amount of energy used in the facility divided by the energy delivered to IT equipment. A perfectly efficient system has a PUE of 1.00. The global average annualized PUE based on 2021 survey respondents was 1.57. There has been a lot of efficiency gains since the 2010s. However, PUEs have been stable for the last five years as all the least expensive sustainability improvement have been made to legacy DCs. In 2007, the global average annual PUE was 2.50. It dropped to 1.65 by 2014 and has been relatively flat since. The Uptime Institute Global Data Center Survey 2021 noted 70% of top responders compile and report PUE and 33% compile and report “IT or Data center Carbon Emissions” for corporate sustainability (2021 Data Center Industry Survey Results-Uptime Institute). A method to improve efficiency at legacy DCs would be valued by DCs, customers and their value chain.

It is worth noting that most of the focus of efficiency gains has been through lowering PUE by pushing heat out into the environment more efficiently, rather than making electronic components produce less heat. This attributes to diminishing marginal gains in PUEs over time.

It is unlikely that DCs will stop producing heat. At a PUE of 1.0, the IT equipment is generating heat even if the supporting infrastructure requires no energy.

DC operate with almost no downtime. DCs require constant cooling because IT equipment generates heat. Many DCs have server operating parameters that require air supply temperature to be 74° F. with 30-60% building humidity. ASHRAE (American Society of Heating, Refrigeration and Air Conditioning Engineers) recommends DC operating range of 18-27° C. (64-81° F.) (Home|ashrae.org). A byproduct of the constant cooling is excess heat pushed out of the DC in some form (warm air or liquid cooling, for example). There is substantial wasted thermal energy in the exhaust from DCs that could be recycled or repurposed.

One of the challenges of recycling waste heat is that the waste heat is warm, but not hot enough to be efficiently converted to other forms of energy. Electricity or steam for example. DC air outlet temperature is typically 20° C. (35° F.) warmer than inlet air. With some conditioning, the exhaust heat is well suited for many types of HDF. Operating efficiency, in the form of reduced heat waste and GHG emissions, can be increased by integrating a DC to a complimentary asset.

HDF requires a controlled climate and operates with little downtime. Typical conditions for HDF are 65-83° F., with 40-75% relative humidity. Supplemental heating is needed when lighting is off and natural cooling takes place from plant transpiration. Transpiration is a natural evaporative process. DC outlet air is 35° F. higher than the inlet air, that would put the outlet air at the upper range of temperature requirements for HDF. In some HDF operations carbon dioxide must be increased beyond ambient levels (1500 ppm) during daytime to speed the rate of photosynthesis. These operational requirements create the need for robust HVAC in HDF.

One of HDF challenges has been real estate. Large scale HDF has specific real estate requirements. Certain HDF embodiments require ceiling height to be over 30 feet high. HDF requires trucking access and proximity to trucking routes. HDF is also typically closer to population centers to reduce shipping and transportation cost. HDF has had to compete for industrial space as market forces push up rents and lower the amount of available space. This is in part due to the expansion of large-scale ecommerce companies. For example, Metro DC industrial rent grew 11.3% from Q4 2020 to Q4 2021 (JLL.com). In addition to industrial space becoming more expensive, the buildout (specialized HVAC, lighting, plumbing, ect . . . ) to make industrial space suitable for HDF is a significant additional capital investment.

HVAC and lighting costs are significant in HDF. The amount of electricity required for HDF is an economic challenge and reduces sustainability. Reducing electric use improves the economics of HDF as well as reduces GHG emissions. GHG emissions are a byproduct of energy generation at large scale. The Environmental Protection Agency's Egrid shows that across the US, 818.3 lbs of carbon dioxide are produced per MWh of electricity (eGRID2020 Summary Tables (epa.gov)). In this way, reduced GHG emissions can be calculated based on the electric grid and the amount of energy savings.

Vegetation in a HDF absorbs carbon dioxide, a primary greenhouse gas in earth's atmosphere, and releases oxygen. In some HDF operations carbon dioxide must be increased beyond ambient levels (1500 ppm) during daytime to speed the rate of photosynthesis.

Both assets, DC and HDF, are enhanced by integration. A connected HDF can act as a heat sink and carbon capture for a DC while the DC reduces operating expense and capital investment costs for HDF. DC exhaust heat is relatively stable and can reduce HVAC costs and capital investment for a HDF facility. HDF would benefit from DC HVAC redundancy because DC uptime is so important.

Electric rate savings for HDF is an additional benefit of integration. DC are generally located in areas with low electric costs and often negotiate lower rates based on volume. The average electric rate for DCs in Northern Virginia is $0.052/kWh (Data center Outlook 2021), while the US Middle-Atlantic commercial electric rate was projected to be $0.1501/kWh for 2023 (7ctab.pdf (eia.gov). HDF sub-metered by the utility that can participate in these lower average electric rates would have a sustainable advantage. Another factor that makes DC and HDF compatible is both require large capital investment and have stable occupancy and usage. Through integration, DC waste heat and carbon dioxide is converted to premium produce rather than released into the environment.

The invention is a real estate solution for HDF. Most existing DCs are one to two stories due to the nature of their operation. This makes DCs inefficient from a land use perspective. This invention would make greater vertical construction more economical by co-locating and integrating DC and HDF. Many existing and planned DCs are close to population centers and trucking routes to reduce latency. The invention reduces HDF capital investment since the use of DC waste heat reduces the need for as much HVAC in HDF. This invention gives HDF to option to avoid the increasingly expensive industrial real estate market and lowers the economic barrier for HDF to reach scale.

### Technical Aspects

The invention disclosed herein is a complete system that improves DC and HDF operating efficiency. DC waste heat exhaust from building climate control systems is used to supply HDF with consistently conditioned air while overall electric use and GHG emissions are reduced. The invention is characterized by the following process and components:

DC is supplied energy through the electrical grid or other means. The DC functions normally. HVAC is required to remove heat from IT equipment to prevent damage. As a byproduct of this normal DC operation, significant waste heat is generated by the DC.

Some DCs are powered by 100% renewable energy. Hydroelectric or geothermal power are an example of renewable energy. As will be understood by the skilled artisan upon reading this disclosure, the power source is not critical. There will be efficiency gains even if only renewable energy is used. However, there can be more efficiency gains in GHG emissions if the DC is on an electrical grid.

In certain embodiments, the invention can be most efficient when retrofitted to legacy DC's with higher average PUE. Fully integrated embodiments can be more efficient (e.g., as compared to non-fully integrated embodiments) from a heat loss perspective.

A conduit from DC HVAC can connect to a Control Station in the HDF facility and transport the DC exhaust. The conduit can be made of commercially available HVAC materials. The conduit can be internal or external depending on the location of the HDF. In some embodiments, the HDF is located adjacent to the DC. In other embodiments the HDF is located above the DC. In other embodiments the DC and HDF are fully integrated as a single building. In other embodiments the DC and HDF are specialized rooms within a lager building or vessel. In still other embodiments the DC and HDF are containerized, or modules or units. The main requirement is that the conduit material is non-porous, and it is of sufficient size to handle the required volume of air or liquid. The conduit can be, but is not limited to, galvanized steel, aluminum, stainless steel, or plastic. Galvanized steel has good corrosion resistance. Aluminum is lighter than steel and stainless steel. Stainless steel is more corrosion resistant than both steel and aluminum. Plastic is light and versatile. The conduit can be of flexible or ridged design. Flexible ducts, which are inexpensive, lightweight, and easy to install, can be used as the conduit. The conduit can be insulated or uninsulated. In certain embodiments, fiberglass lined ducts (which have the advantage of being better insulated and reduces energy loss and noise) can be used. In certain embodiments, fiberboard ducts (which are similar in that they provide some insulation and noise reduction) can be used. As will be understood by the skilled artisan upon reading this disclosure, the choice of material and style may impact effectiveness and efficiency but are not critical to the design of the invention. In certain embodiments, the conduit can have a plurality of sensors (e.g., incorporated sensors) in communication (e.g., electronic communication) with the Control Station. Various methods known in the art can be adapted for use in the invention. Requirements will vary based on the DC, HDF, and the HVAC used in each. In certain embodiments, it can be advantageous to have the conduit as short as possible to reduce energy loss.

The conduit can connect to the Control Station. In some embodiments, the Control Station can be located directly adjacent to the HDF. In other embodiments, the Control Station can be located inside the HDF. In other embodiments, the Control Station can be located directly adjacent to the DC. In other embodiments, the Control Station can be located inside the DC. In other embodiments, the Control Station can be located along the conduit. The purpose of the Control Station is to communicate with the HDF HVAC system and the conduit. The Control Station can be connected directly to the conduit and the HDF HVAC. Air filtration occurs at the junction of the conduit and HDF HVAC. The filtration process may be performed using known methods and apparatuses. The conduit and HDF HVAC can also include sensors and other monitoring devices in communication (e.g., electronic communication) with the Control Station. Parameters which can be monitored include, but are not limited to temperature, pressure, humidity, carbon dioxide, particulate matter, and air volume. The Control Station can include a processor adapted to process the measured parameters fed back from the sensors and monitors, and to use the data to alter control parameters such as, but not limited to temperature, pressure, humidity, carbon dioxide levels, particulate matter, and air or liquid volume. The control system can be configured and adapted to regulate the conditioned fluid (e.g., conditioned air, conditioned exhaust, etc.) provided by the HVAC system. In some embodiments, the Control Station can have HVAC equipment to increase the force needed to draw air (e.g., via a fan, a blower, a pumping apparatus, etc.) into the HDF facility. In the case of a purely liquid cooling system, a pump would be used to serve the same function. The type and design of this HVAC equipment will vary, in part, based on the conduit length and air or liquid volume.

The HDF is designed to be of suitable size for the intended type and amount of vegetation to be grown. In some embodiments, the HDF is of a temporary construction design. In other embodiments, the HDF is of a permanent construction design, including being fully integrated with a DC into a single facility. In some embodiments, the HDF is constructed of opaque material. In other embodiments, the HDF is constructed of transparent or translucent materials to allow for natural lighting. In still other embodiments, the HDF exterior surface has solar panels or wind turbines to take advantage of environmental energy production.

The HDF functions normally. DC exhaust travels through the conduit to the Control Station where it is filtered and properly conditioned before reaching the HDF HVAC. The exhaust is conditioned to appropriate levels such as, but not limited to temperature, pressure, humidity, carbon dioxide levels, particulate matter, and air volume. The conditioned air provides heat and carbon dioxide required by vegetation in the HDF. Supplemental heating can be needed when lighting is off and natural cooling takes place from plant transpiration.

In some embodiments the conditioned exhaust travels through the Control Station into HDF HVAC and circulates with the interior climate until exhausted from the HDF facility.

In some embodiments, the HDF interior climate is separated from the DC exhaust by a non-porous barrier. In certain embodiments, heat from the DC exhaust is exchanged using HVAC equipment and DC exhaust is not circulated with the HDF HVAC interior climate. In this situation, the conditioned exhaust is used primarily for heating. In some embodiments, this takes the form of a radiant heat system. Both air and liquid radiant heating systems are commercially available. Radiant heating can be installed in the floor or aluminum wall panels. The conditioned exhaust flows through coils placed in the floor or walls. The radiant heat system does not need to be of permanent design. The conduit could be run through gravel or installed in a gap between flooring material. In some permanent designs, the radiant heating system is inlaid directly into a concrete foundation. In this system heat radiates through the coils to heat the HDF.

In other embodiments, the radiant heat is exchanged in a container or pool of water located inside the HDF. The heat then radiates from the warmed water to the interior environment of the HDF. In the case of a DC with purely liquid cooling system, the cooled liquid would be returned through the conduit back to the DC to complete its loop after the heat has been absorbed by the HDF. This embodiment could be advantageous if the HDF requires high humidity.

In still other embodiments, the conditioned exhaust can move through the HDF facility, but the farming areas can be containerized. HDF containers are often configured with an air handling unit at the rear (e.g., of each container). There can be wall cutouts where the air-handling units can interface with the outside environment. The exact configuration of the containerized or modular system is not critical to the overall design. However, one advantage of this design is the container air-handling units can act as backup HVAC in the event of interrupted conditioned exhaust flow or power loss.

One advantage of placing a barrier between the HDF interior climate is that carbon dioxide levels can be better regulated since conditioned air is not circulating through the interior HDF climate.

In some embodiments, the HDF is located above the DC and both buildings are completely separated across the full floor to provide uninterrupted leakage barrier. In this embodiment, radiant heating could be used while keeping the floor fully separate. In other rooftop embodiments, there can be internal connections to the HVAC system. The conduit can pass from the DC to the Control Station without the conduit being exposed to the outside environment. One advantage is there can be less heat loss through the conduit since it will be relatively short and not exposed to the outside environment.

The HDF can be supplied energy through the electrical grid or other means. The primary uses of such energy are HVAC and lighting. As will be understood by the skilled artisan upon reading this disclosure, the power source is not critical, and various methods known in the art can be adapted for use in the invention. There can be efficiency gains even if only renewable energy is used. However, there can be more efficiency gains in GHG emissions if the HDF is on an electrical grid. There can be additional efficiency gains in cold environments since heating cost will be reduced.

Unused DC exhaust can then be exhausted from the HDF facility.

The entire system is well suited for automatic, computerized operation.

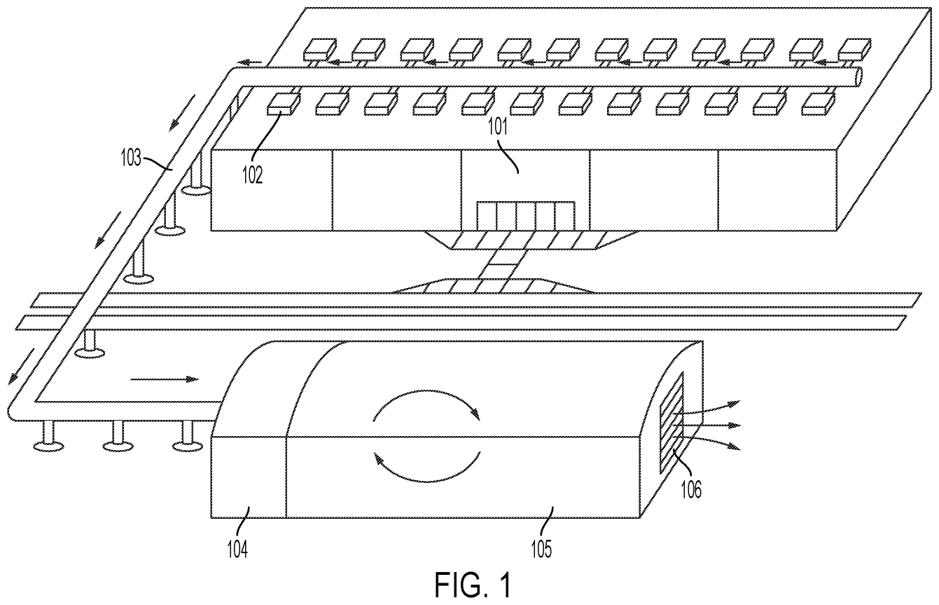

FIG. 1 schematically illustrates, in an out of scale manner, an exterior view of an embodiment of the invention retrofit to an existing DC with temporary HDF design. FIG. 1 illustrates DC 101, rooftop DC HVAC 102 (e.g., a rooftop DC HVAC), conduit 103, Control Station 104, HDF 105, and HDF exhaust 106 (e.g., an outlet). The arrows in the illustration indicate directional flow of DC exhaust. DC 101 can be supplied energy through an electrical grid or other mechanisms (not shown); DC 101 can be considered to and function normally. DC HVAC 102 can be used to remove heat from IT equipment (e.g., to prevent damage, to improve operational functionality, etc.). As a byproduct of a normal DC 101 operation, significant waste heat can be generated by DC 101. A conduit 103 is illustrated connecting DC HVAC 102 to the Control Station 104 in the facility of HDF 105 and transporting DC exhaust. Conduit 103 can be made of commercially available non-porous HVAC materials. Control Station 104 can communicate with the HDF HVAC (interior and not shown) system and the conduit 103. Conduit 103 and HDF HVAC (not shown) can also include sensors and other monitoring devices in communication with Control Station 104. Parameters which can be monitored include, but are not limited to temperature, pressure, humidity, carbon dioxide, particulate matter, and air volume. Control Station 104 can include a processor adapted to process the measured parameters fed back from the sensors and monitors, and to use the data to alter control parameters. DC exhaust is filtered and properly conditioned appropriate to HDF in the Control Station 104. The HDF 105 functions normally. The conditioned air provides heat and carbon dioxide required by vegetation (e.g., a plurality of vegetation) in HDF 105. In the illustrated embodiment, the conditioned exhaust travels through the Control Station 104 into HDF HVAC (not shown) and circulates with the interior climate of the HDF 105. Unused conditioned exhaust can then be exhausted through and outlet of HDF exhaust 106 of the HDF 105.

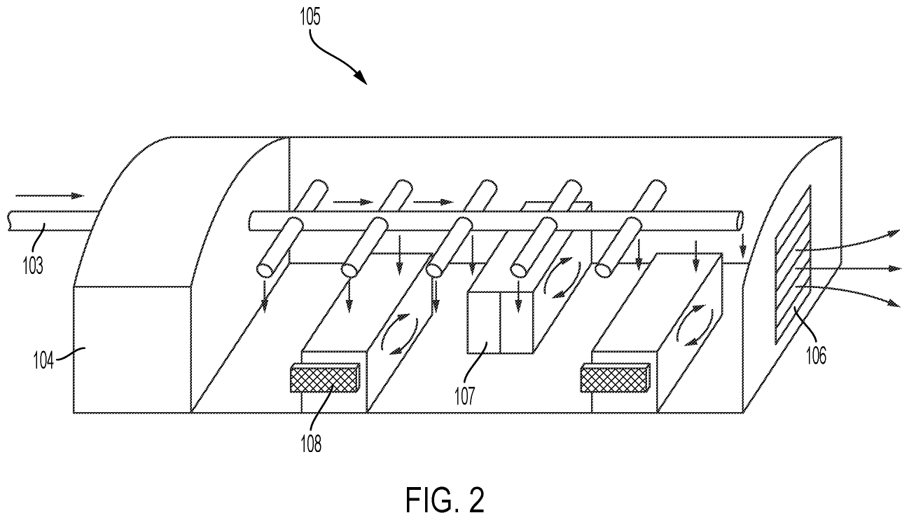

FIG. 2 schematically illustrates, in an out of scale manner, a partially sectional side view of an embodiment of invention with a containerized HDF system. FIG. 2 illustrates conduit 103, Control Station 104, HDF 105, HDF exhaust 106, containerized HDF units 107, and wall cutouts 108 for containerized HDF HVAC. The arrows in the illustration indicate directional flow of air or DC exhaust. FIG. 2 illustrates an embodiment where conditioned exhaust moves through the HDF 105 facility, but where the farming areas are containerized 107 and maintain a separate climate. One advantage of placing a barrier between the interior climate and the conditioned exhaust is that carbon dioxide levels can be better regulated (e.g., since conditioned air is not circulating through the interior HDF 105 climate). HDF containers 107 pictured have air handling unit at the rear. There are wall cutouts 108 where the HVAC can interface with the outside environment. One advantage of such an embodiment is the container 107 air-handling units can act as backup HVAC in the event of interrupted conditioned exhaust flow or power loss. The exact configuration of the containerized or modular system is not critical to the overall design.

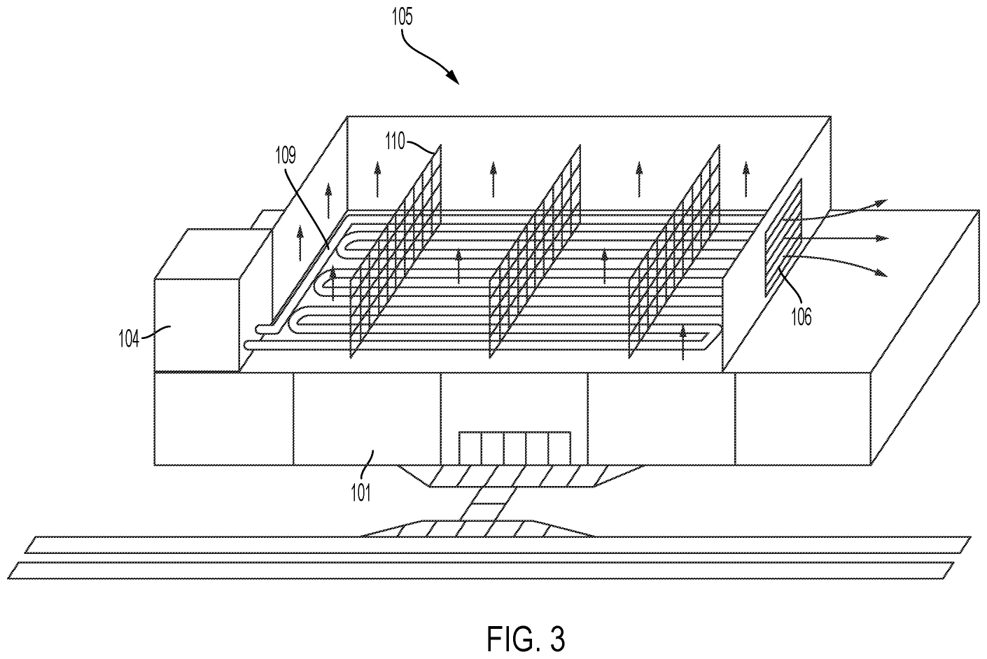

FIG. 3 schematically illustrates, in an out of scale manner, a partially sectional side view of an embodiment of the invention with rooftop HDF and a radiant heating system. FIG. 3 illustrates DC 101, Control Station 104, HDF 105, HDF exhaust 106, radiant heat system 109, and vertical HDF racks 110. The arrows in the illustration indicate directional flow of heat or DC exhaust. FIG. 3 illustrates an embodiment where conditioned exhaust can be used for radiant heating of a rooftop HDF 105. In the illustrated embodiment, the HDF 105 interior climate is separated from the DC exhaust by a non-porous barrier, the floor. In the illustrated embodiment, vertical HDF racks 110 (e.g., 30′ vertical HDF racks) are in use. As will be understood by the skilled artisan upon reading this disclosure, the number or design of the vertical HDF racks is not critical, and various farming methods known in the art can be adapted for use in the invention. In the illustrated embodiment, the HDF 105 is located above the DC 101 and both buildings are completely separated across the full HDF floor to provide uninterrupted leakage barrier. One advantage of placing a barrier between the interior climate and the conditioned exhaust is that carbon dioxide levels can be better regulated since conditioned air is not circulating through the interior HDF 105 climate. In this permanent construction design, the radiant heating system 109 is inlaid directly into a concrete foundation. The conditioned exhaust from the DC 101 is used for heating. Both air and liquid radiant heating systems 109 are commercially available. Radiant heating can be installed in the floor or aluminum wall panels. The conditioned exhaust flows through the coils placed in the floor or walls. Heat radiates through the coils to heat the HDF 105. One advantage of having DC 101 and HDF 105 located close to each other is that less thermal energy from the DC exhaust is lost in transport.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

The following presents a simplified summary of aspects of certain embodiments of the present disclosure. In one aspect, the present invention provides premium produce with no pests, pesticides, insecticides, herbicides, fungicides, and reduces contamination risk with little or no washing. In another aspect, the present invention provides less waste from unattractive produce (bruising, sunspots, discoloration, poorly formed, etc.) as light and climate conditions are controlled. In another aspect, the present invention moves farming closer to the end consumer, reducing transportation time, transportation cost, and storage cost. In another aspect, the present invention provides produce will have a longer shelf-life because it can be harvested year-around and closer to the end user. In another aspect, the present invention provides a hedge against climate and weather events including but not limited to drought, flooding, wind, wildfire, and hail. In another aspect, the present invention provides enhanced growing cycles per year due to controlled climate. In another aspect, the present invention requires less water as compared to traditional outdoor farming. In another aspect, the present invention requires less nutrients and fertilizer as compared to traditional outdoor farming. In another aspect, the present invention provides a sustainable cost advantage from HVAC savings created by recycling DC waste heat. In another aspect, the present invention reduces emission of GHG by reducing electrical use through increased efficiency. In another aspect, the present invention reduces the emission of GHG by having vegetation in HDF capture carbon dioxide for photosynthesis. In another aspect, the present invention is scalable in size and number. In another aspect, the present invention provides a superior real estate solution to highly sought-after industrial space in terms of cost and efficiency. In another aspect, the present invention aids development, tax rebate, tax credit, or tax incentive discussions with local municipalities. In another aspect, the present invention provides a more productive use of land allowing for greater vertical construction.

In another aspect, the present invention provides sustainable advantages by combining two types of real estate assets, DCs and HDF, to create a new asset type. The system can use waste exhaust from DC's to 1) reduce climate control costs for a rooftop, adjacent, or integrated HDF operations, and 2) reduce greenhouse gas emissions through increased efficiency and plant photosynthesis. An advantage for DC's is that waste heat is recycled, and greenhouse gas emissions are reduced. An advantage for HDF is HVAC capital investment and operating electric costs are reduced while carbon dioxide is used for photosynthesis by vegetation inside the HDF facility. The main inputs to the system are waste heat and carbon dioxide. The main outputs are high quality produce, cooled air, and oxygen.

In another aspect, the present invention provides a process wherein DC is supplied energy through the electrical grid or other means and functions normally. DC HVAC exhaust is produced. A conduit from DC HVAC connects to the Control Station by the HDF facility and transports the DC exhaust. The conduit connects to the Control Station. The control station conditions the DC exhaust appropriate for HDF. The conditioned exhaust is then delivered to the HDF HVAC system. The HDF functions normally. Unused conditioned DC exhaust is then exhausted from the HDF facility.

In another aspect, the present invention provides a system for integration of DC and HDF; by integrating these two asset types, heat waste from a DC can be used to reduce HVAC costs for a HDF facility thereby reducing electric costs and GHG emissions. The HDF acts as a cost-effective heat sink and carbon capture for the DC.

### ENUMERATED EMBODIMENTS

The following enumerated embodiments are provided, the numbering of which is not to be construed as designating levels of importance.

Embodiment 1 provides a system including: a data center (DC) including a plurality of information technology (IT) equipment and a heating-ventilation-and-air-conditioning (HVAC) system including conduit, the HVAC system being configured and adapted to remove thermal energy from the plurality of IT equipment; and a high density farming (HDF) system in proximity to the DC, the HDF system being configured and adapted to support vegetation, wherein the HVAC system is configured and adapted to provide the removed thermal energy to the HDF system through a conditioned fluid.

Embodiment 2 provides the system of embodiment 1, wherein the conduit is made from a non-porous material.

Embodiment 3 provides the system of any one of embodiments 1-2, wherein the conduit is made from a material selected from the group consisting of: galvanized steel, aluminum, stainless steel, and plastic.

Embodiment 4 provides the system of any one of embodiments 1-3, wherein the HDF system includes a control station.

Embodiment 5 provides the system of any one of embodiments 1-4, wherein the conduit includes a plurality of sensors in electronic communication with the control station.

Embodiment 6 provides the system of any one of embodiments 1-5, wherein the control system includes a processor configured and adapted to process measured parameters selected from the group consisting of: temperature, pressure, humidity, carbon dioxide levels, particulate matter, air volume, and liquid volume, wherein the control system is configured and adapted to regulate the conditioned fluid provided by the HVAC system.

Embodiment 7 provides the system of any one of embodiments 1-6, wherein the HDF system is positioned adjacent to the DC.

Embodiment 8 provides the system of any one of embodiments 1-6, wherein the HDF system is positioned above to the DC.

Embodiment 9 provides the system of any one of embodiments 1-8, wherein the HDF system includes a plurality of containerized HDF units.

Embodiment 10 provides the system of any one of embodiments 1-9, wherein the HDF system includes a plurality of vertical HDF racks.

Embodiment 11 provides the system of any one of embodiments 1-10, wherein the HDF system includes a radiant heat system configured and adapted to receive the conditioned fluid from the DC and transfer the heat to the HDF without combining the conditioned fluid with an interior environment of the HDF system.

Embodiment 12 provides a method including: (a) providing a data center (DC) including a plurality of information technology (IT) equipment, and a heating-ventilation-and-air-conditioning (HVAC) system configured and adapted to remove thermal energy from the plurality of IT equipment, the HVAC system including conduit; and (b) providing a high density farming (HDF) system in proximity to the DC; wherein the HVAC system is configured and adapted to provide the removed thermal energy to the HDF system via a conditioned fluid.

Embodiment 13 provides the method of any one of embodiments 12, further including: providing electric energy to the DC, wherein the electric energy is converted at least in part to thermal energy.

Embodiment 14 provides the method of any one of embodiments 12-13, further including: using the HDF system as a heat sink.

Embodiment 15 provides the method of any one of embodiments 12-14, further including: capturing carbon from the DC via the HDF system.

Embodiment 16 provides the method of any one of embodiments 12-15, further including: configuring the conduit to provide the removed thermal energy to the HDF system via the conditioned fluid.

1. A system comprising:
a data center (DC) including:
a plurality of information technology (IT) equipment; and
a heating-ventilation-and-air-conditioning (HVAC) system including conduit, the HVAC system being configured and adapted to remove thermal energy from the plurality of IT equipment; and
a high density farming (HDF) system in proximity to the DC, the HDF system being configured and adapted to support vegetation,
wherein the HVAC system is configured and adapted to provide the removed thermal energy to the HDF system through a conditioned fluid.

2. The system of claim 1, wherein the conduit is made from a non-porous material.

3. The system of claim 1, wherein the conduit is made from a material selected from the group consisting of: galvanized steel, aluminum, stainless steel, and plastic.

4. The system of claim 1, wherein the HDF system includes a control station.

5. The system of claim 4, wherein the conduit includes a plurality of sensors in electronic communication with the control station.

6. The system of claim 5, wherein the control system includes a processor configured and adapted to process measured parameters selected from the group consisting of: temperature, pressure, humidity, carbon dioxide levels, particulate matter, air volume, and liquid volume, wherein the control system is configured and adapted to regulate the conditioned fluid provided by the HVAC system.

7. The system of claim 1, wherein the HDF system is positioned adjacent to the DC.

8. The system of claim 1, wherein the HDF system is positioned above to the DC.

9. The system of claim 1, wherein the HDF system includes a plurality of containerized HDF units.

10. The system of claim 1, wherein the HDF system includes a plurality of vertical HDF racks.

11. The system of claim 1, wherein the HDF system includes a radiant heat system configured and adapted to receive the conditioned fluid from the DC and transfer the heat to the HDF without combining the conditioned fluid with an interior environment of the HDF system.

12. A method comprising:
providing a data center (DC) including:
a plurality of information technology (IT) equipment; and
a heating-ventilation-and-air-conditioning (HVAC) system configured and adapted to remove thermal energy from the plurality of IT equipment, the HVAC system including conduit; and
providing a high density farming (HDF) system in proximity to the DC;
wherein the HVAC system is configured and adapted to provide the removed thermal energy to the HDF system via a conditioned fluid.

13. The method of claim 12, further comprising:
providing electric energy to the DC, wherein the electric energy is converted at least in part to thermal energy.

14. The method of claim 12, further comprising:
using the HDF system as a heat sink.

15. The method of claim 12, further comprising:
capturing carbon from the DC via the HDF system.

16. The method of claim 12, further comprising:
configuring the conduit to provide the removed thermal energy to the HDF system via the conditioned fluid.
